(19) United States
(12) Patent Application Publication
(10) Pub. No.: US 2006/0252005 A1
(43) Pub. Date: Nov. 9, 2006

(54) Apparatus for providing radiation at multiple wavelengths and method of operating same

(76) Inventors: Richard E. Feinbloom, New York, NY (US); Peter Yan, Rego Park, NY (US)

Correspondence Address: PLEVY & HOWARD, P.C., P.O. BOX 226, FORT WASHINGTON, PA, 19034, US

(21) Appl. No.: 11/430,095

(22) Filed: May 8, 2006

Related U.S. Application Data
(60) Provisional application No. 60/678,680, filed on May 6, 2005.

(51) Int. Cl. A61C 3/00

(52) U.S. Cl. 433/29

(57) ABSTRACT

A device for providing radiation to a selected incident location has a first light emitting device adapted to emit light in a band having a peak at a first wavelength, a plurality of second light emitting devices adapted to emit light in a band having a peak at a second wavelength, the second light emitting devices being arranged circumferentially about the first light emitting device, at least a first optical component to receive light from the first light-emitting device and to provide light to the selected incident location; and at least a second optical component to provide light from the second light emitting devices to the selected incident location.

### RELATED APPLICATIONS

This application claims the benefit of U.S. Provisional Patent Application No. 60/678,680, filed May 6, 2005, which application is hereby incorporated herein by reference in its entirety.

### FIELD OF THE INVENTION

This invention is in the field of providing radiation at various wavelengths, for applications including curing of dental adhesives.

### BACKGROUND

Devices for emitting radiation at selected wavelengths are used for a variety of applications. One example of such applications is in the curing of certain types of adhesives, and in particular in the intraoral curing of adhesives in dentistry. Not all light-curable dental adhesives cure at the same wavelength. For example, one commonly used photoinitiator for dental adhesives, PPD, has peak absorption of light at a wavelength of around 405 nanometers (nm), while a second commonly used photoinitiator for dental adhesives, CQ, has a peak absorption of light at around 470 nm.

Light emitting units used by dentists, or dental curing units, have long used halogen bulbs as their light source. Halogen bulbs provide a broad range of wavelengths, and thus are usable for curing various types of dental adhesive noted above. The light from a halogen bulb is received at one face of a fiber optic light tip. Light tips are typically curved to permit positioning within a patient's mouth adjacent the dental adhesive. The light tips are generally removable and may be sterilized in an autoclave and reused.

Light emitting diodes and similar light-emitting devices provide a number of advantages over halogen bulbs, and therefore have been used for dental curing units. These advantages include lower power consumption, which facilitates longer battery life and thus use in cordless handheld dental curing units, lower generation of heat, and consistent illumination over the life of the device. However, light-emitting diodes emit radiation over a relatively limited range of wavelengths compared to halogen bulbs. Common, commercially available diodes are available to cure dental adhesives curable with a peak around 470 nm. Commercially available diodes are also suitable for curing of dental adhesives that cure in the higher wavelength ranges noted above. However, there is no single light-emitting diode available for curing of both types of adhesive.

The Ultra-Lume brand LED 5, from Ultradent Products, Inc. is a dental curing light having a head with several LED's emitting at a variety of wavelengths. Unlike a fiber optic light tip, the head of the Ultra-Lume brand LED 5 is not suitable to be autoclaved. Sterilization between patients is thus rendered more difficult.

A further disadvantage of dental curing lights of the prior art relates to timing of curing. Control circuits for dental curing lights of the prior art generally permit the user to select a cure time, which is stored temporarily, and press an on/off button to activate the curing light for the selected cure time. If the on/off button is pressed before the cure time expires, the curing light is deactivated, and the memory is cleared. The operator then does not know for how much time the adhesive was exposed to the curing light. Since curing will be adequate after a brief interruption in exposure to the curing light, the operator may expose the material to be cured for an unnecessarily long period of time.

### SUMMARY OF THE INVENTION

A device for providing radiation to a selected incident location has a first light emitting device adapted to emit light in a band having a peak at a first wavelength, a plurality of second light emitting devices adapted to emit light in a band having a peak at a second wavelength, the second light emitting devices being arranged circumferentially about the first light emitting device, at least a first optical component to receive light from the first light-emitting device and to provide light to the selected incident location; and at least a second optical component to provide light from the second light emitting devices to the selected incident location. The first optical components may include a collimator located to receive light emitted by the first light emitting device and a first lens located to receive light from the collimator and to provide light to the selected incident location. The second optical components may include a second lens located axially outward from the first lens. In an alternative embodiment, the first optical components may include an elliptical reflector.

A method for providing radiation to a selected incident location includes the steps of emitting light at a first wavelength from a first light emitting device, simultaneously emitting light at a second wavelength from a plurality of second light emitting devices arranged circumferentially about the first light emitting device; collimating and focusing the light at the first wavelength on the selected incident location; and focusing the light at the second wavelength on the selected incident location.

A method of operating a dental curing unit includes the steps of receiving an indication of a selected curing time; storing the selected curing time in memory; upon receiving a curing start input, causing the dental curing unit to commence radiation emission for curing, determining and displaying an elapsed curing time during the step of emission of radiation, receiving an interruption signal, interrupting radiation emission in response to the interruption signal, determining an elapsed interruption time, receiving a second curing start input, and causing the dental curing unit to continue radiation emission for the remainder of the selected curing time if the elapsed interruption time is less than a maximum interruption time, and otherwise resuming radiation emission for the entire selected curing time.

A cradle for a radiation emitting unit includes a housing having a generally continuous outer wall; at least one electrical connector, associated with the housing, for providing current to a radiation emitting unit associated with the housing; a first radiometer port defined in the wall and having associated therewith a detector for measuring radiation in the infrared range; a second radiometer port defined in the wall and having associated therewith a detector for measuring radiation in the ultraviolet range; and a display associated with the housing for displaying radiation intensities detected by the detectors.

### BRIEF DESCRIPTION OF THE FIGURES

FIG. 1 is a perspective view of a dental curing unit according to an embodiment of the invention.

FIG. 2 is a partial perspective view showing operational components of the dental curing unit of FIG. 1.

FIG. 3 is a partial section of a device for irradiating shown in FIG. 2.

FIG. 4 is a section of the device of FIG. 2.

FIG. 5 is an alternative embodiment of the device of FIG. 2.

FIG. 6 is an isometric view of the device for irradiating of FIGS. 2 and 5, with lenses and collimator or reflector removed.

FIG. 7 is a block diagram for a dental curing unit according to an embodiment of the invention.

FIGS. 8A and 8B show a high-level process flow for a method of operating a curing unit according to an embodiment of the invention.

FIGS. 9A, 9B, 9C and 9D show a detailed process flow for a method of operating a curing unit according to an embodiment of the invention.

FIG. 10 is a representation of a signal for driving a light-emitting device in an embodiment of the invention.

FIG. 11 is an illustration of a cradle for a light-emitting device in an embodiment of the invention.

### DETAILED DESCRIPTION

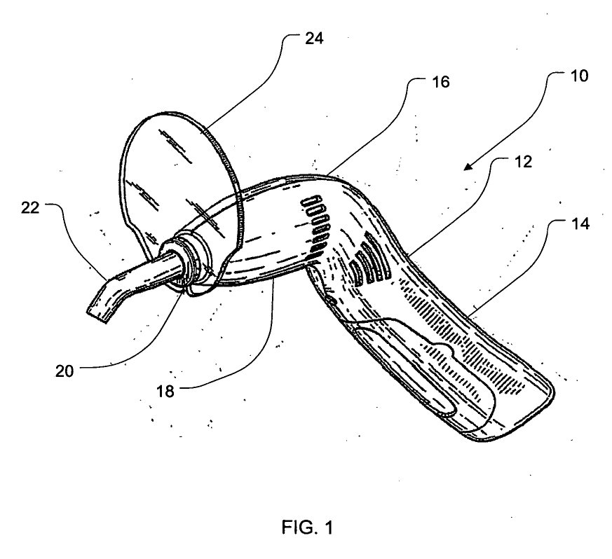

Referring now to FIG. 1, dental curing unit 10 in accordance with an embodiment of the invention is illustrated. Dental curing unit 10 generally has a housing 12 adapted to be held in the hand at a handgrip portion 14, a central curving portion 16, and a tapering head portion 18. Head portion 18 has a connector 20 adapted to releasably position and secure removable light tip 22. Light tip 22 is preferably able to rotate in connector 20. Removable shield 24 is preferably transparent and may be coated or treated to provide shielding against ultraviolet radiation.

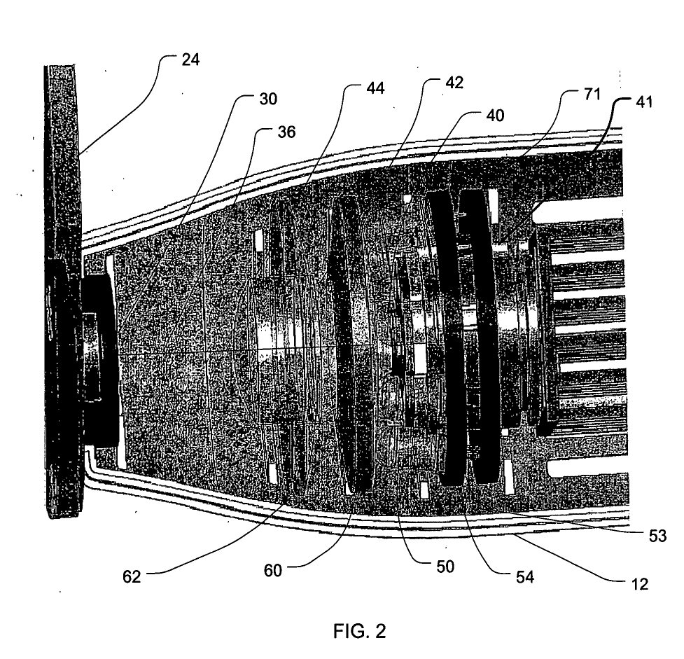

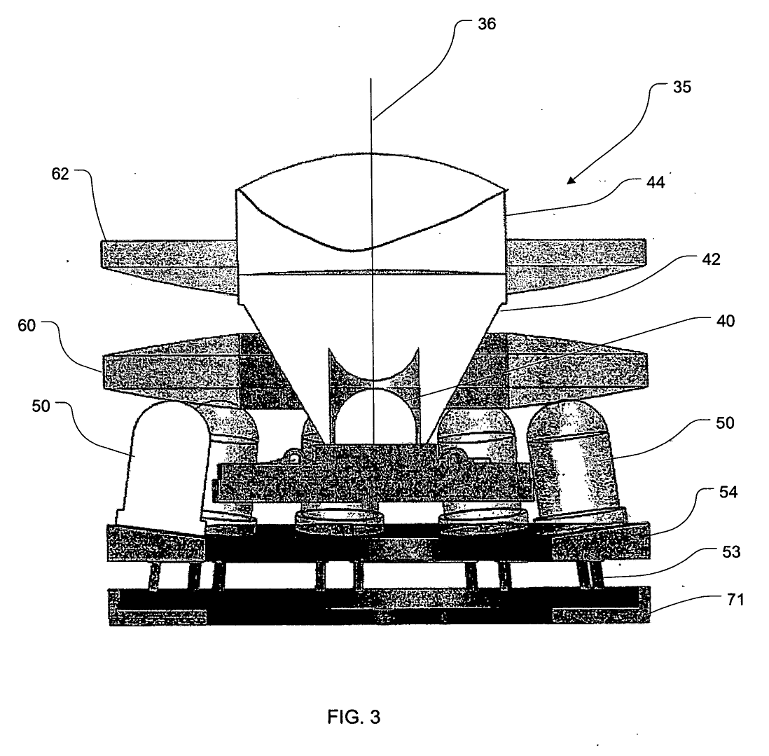

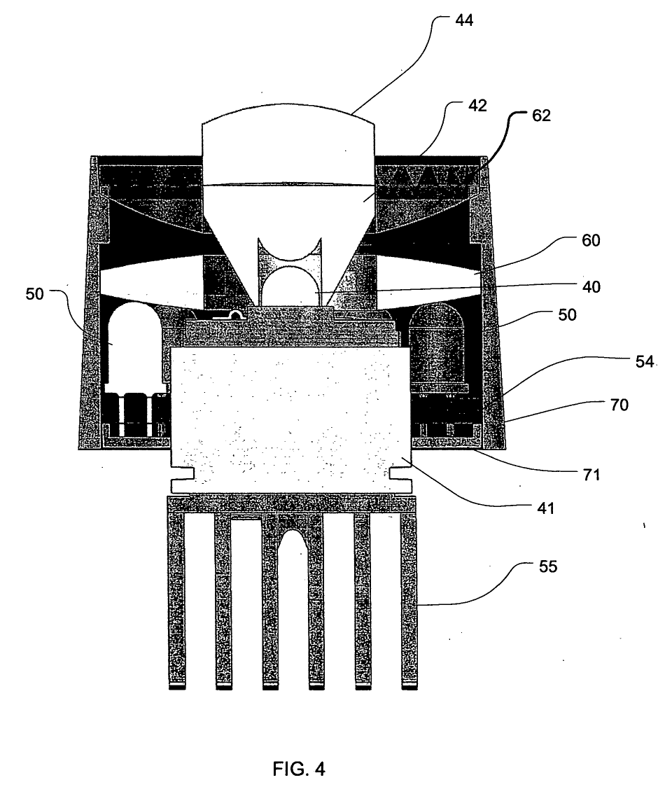

Referring now to FIG. 2, a partial isometric view of the dental curing unit 10, with one-half of housing 12 removed, is provided. The components of dental curing unit 10 that define a device for providing light to an incident location will now be described. In the illustrated embodiment, the incident location is illustrated at 30, and is a position for mounting of an incident face of a light tip, such as light tip 22 shown in FIG. 1. Components constituting a device 35 for providing radiation to incident location 30 are illustrated. The device 35 of FIG. 2 is shown in greater detail in section in FIGS. 3 and 4. A first light-emitting device 40, which may be a light-emitting diode, is shown. First light-emitting device 40 is mounted along a central longitudinal axis 36. First light-emitting device 40 may emit radiation in a band having a peak at a first wavelength from about 455 nm to about 475 nm. By way of example, first light-emitting device 40 may be a Luxeon Dental LED. Such an LED typically emits radiation in a relatively narrow band with a peak at the first wavelength. While the bandwidth of such a relatively narrow band may vary, the width at 50% of peak emissions may be about 20 nm, for example. At least a first optical component may provide light emitted by the first light-emitting device 40 to incident location 30. In this embodiment, the first optical component includes collimator 42 and lens 44. Collimator 42 is provided to collimate light emitted from light-emitting device 40. Collimated light emitted from collimator 42 is focused by lens 44 to incident location 30. First light-emitting device 40, collimator 42, and lens 44 are all centered on a common central axis, indicated generally at 36, which also passes through a center point of incident location 30.

Second light emitting devices 50 are arranged generally circumferentially about first light-emitting device 40. Second light-emitting devices 50 may be disposed equidistant from central axis 36 and on a plane orthogonal to central axis 36. Second light-emitting devices 50 emit light in a band having a peak at a second wavelength different from the first wavelength. Second light-emitting devices 50 may also be light-emitting diodes that emit radiation in a narrow band around a peak wavelength providing a peak, with sharply dropping radiation emission at wavelengths near the peak. By way of example, the bandwidth at 50% of peak intensity may be about 30 nm. The number of second light-emitting devices may be selected by those of skill in the art as desired. In one embodiment, nine second light-emitting devices, at constant angular intervals are provided, emitting at a wavelength of about 405 nm. The second light emitting devices may be, by way of example, LEDs from Ledtronics, Inc., of Torrance, Calif., Part No. L200CUV405-8D.

Second optical components may be provided for providing light emitted by second light emitting devices 50 to selected incident area 30. The second optical components may be second lenses 60, 62, which are positioned to receive light emitted by second light emitting devices 50 and focus the received light on the selected incident area 30. As best seen in FIG. 3, lens 60 is generally a bi-convex lens, and lens 62 is a piano-convex lens. Those of skill in the art in the optical field will be able to select and design suitable lenses for conveying light from second light emitting devices 50 to selected incident area 30.

Light emitted by first light-emitting device 40 proceeds to the selected incident area 30 in a first optical path that includes first optical components collimator 42 and lens 44. The first optical path does not include second optical components, which are lenses 60, 62 in this embodiment. Thus, light emitted by first light-emitting device 40 is directed to selected incident area 30 interacting exclusively with first optical components. Light emitted by second light-emitting devices 50 is directed to selected incident area 30 in a second optical path that includes second optical components, which are lenses 60, 62, in this embodiment. The second optical path does not include the first optical components. Thus, light emitted by second light-emitting devices 50 is directed to selected incident area 30 interacting exclusively with second optical components.

First light-emitting device 40 may be mounted on mount 41, seen in FIGS. 2 and 4, which provides a physical support and electrical connections for first light-emitting device 40. Mount 41 may include a solid body that is a good heat conductor, and may include a solid body of copper. For clarity of view, mount 41 is not shown in FIG. 3. Second light-emitting devices 50 may be physically mounted on circuit board 54, which may be in the form of a ring. Second light-emitting devices 50 may be mounted tilted toward axis 36 at a suitable angle, such as about 8 degrees from vertical, in order to limit the amount of emitted illumination that does not strike the lenses.

Contacts 53 are electrically connected to circuit board 54, and may extend slightly beyond circuit board 54. Second light-emitting devices may be connected in series to a power source through connections on circuit board 54. Heat sink 55, attached to mount 41 so that heat is conducted well from mount 41 to heat sink 55, is provided to dissipate heat radiated by the operation of first light-emitting device 40. A fan may be provided to circulate air over heat sink 55 for additional cooling, although other arrangements may be provided for heat dissipation. In FIG. 4, a cylindrical cup or support 70, which serves as a housing for device 35, in which various components are mounted, is also shown. A suitable epoxy may be employed to mount components in the support 70. Support 70 has a cylindrical closing cap 71.

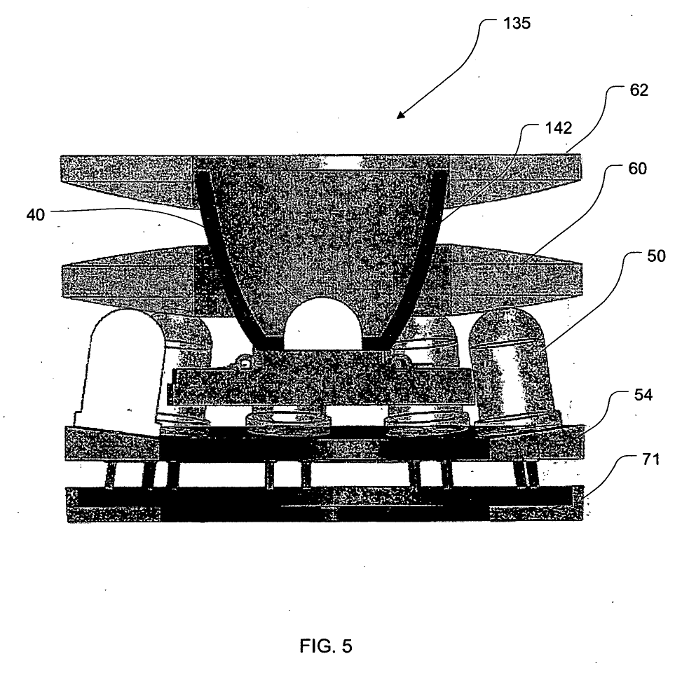

Referring to FIG. 5, an alternative embodiment 135 of the device 35 for providing illumination to a selected incident area or location is illustrated. In this alternative embodiment, the first optical component is an elliptical metallized reflector 142, which focuses light emitted by first light emitting device 40 to selected incident location 30. Thus, reflector 142 is located to reflect light emitting by first light emitting device 40 to the selected incident area. First light-emitting device 40 and reflector 140 are centered on a common central axis which also passes through a center point of incident location 30. Second light-emitting devices 50, circuit board 52, and cap 71 and second optical components 60, 62, are

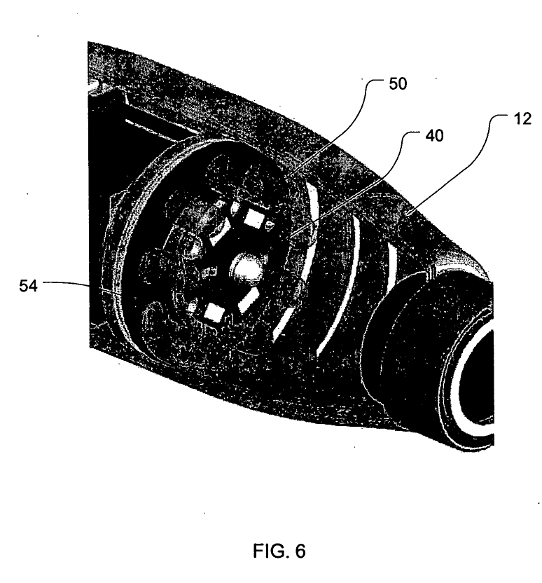

Referring to FIG. 6, the device 35 of FIG. 2 is shown in an isometric view, with the lenses and collimator removed. It can be seen that first light emitting device 40 is centrally located, and second light emitting devices 50 are located on a circle centered on first light emitting device 40 and disposed at even angular intervals. As noted above, the disclosed embodiment has nine second light emitting devices 50.

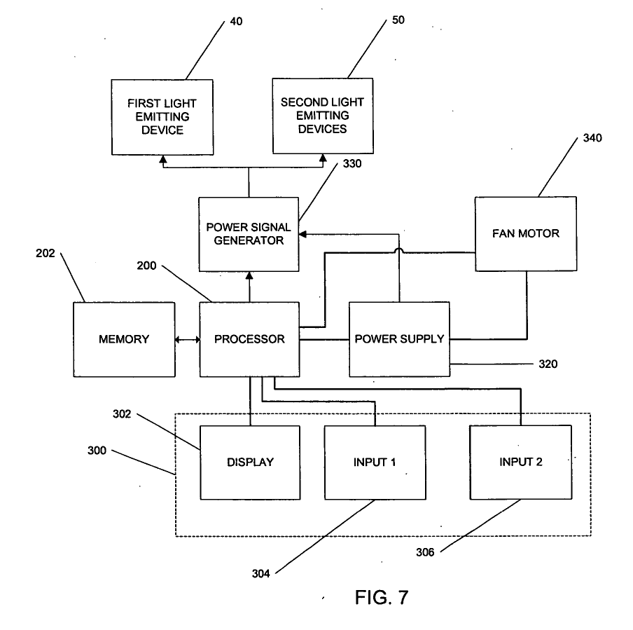

Referring to FIG. 7, a block diagram of components of a dental curing unit in accordance with an embodiment of the invention will now be described. Processor 200 operates in accordance with software or firmware to carry out the instructions described in this application. Any suitable digital processor or combination of processors may be employed. Memory 202 stores information in accordance with instructions from processor 200 and permits information to be retrieved from memory. A user interface 300 includes at least display 302, first input 304, and second input 306. Display 302, which receives controls signals from processor 200, may be a numeric display, such as a two or three digit numeric display. First and second inputs 304, 306, which provide data to processor 200, may be switches or buttons of various types. Power supply 320 may be a rechargeable battery providing DC output to all of the disclosed devices. Fan motor 340 generally designates a motor for a cooling device, such as a fan to move ambient air through openings in housing 12 and across heat sink 55. Processor 200 provides control signals to switches or other controls to operate fan motor 340. First light emitting device 40 and second light emitting devices 50 have been described above. Power signal generator 330 may provide a selected power signal to each of first and second light emitting devices 40, 50, in accordance with signals from processor 200.

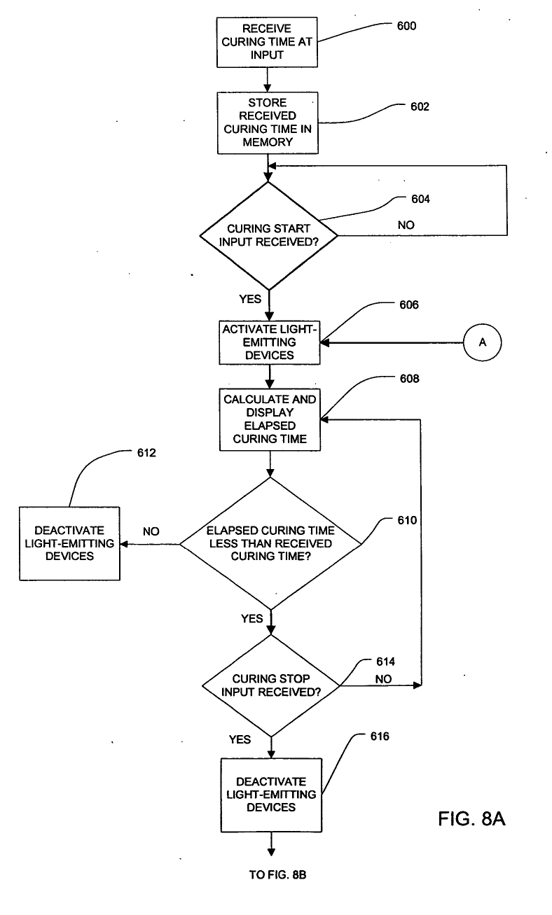

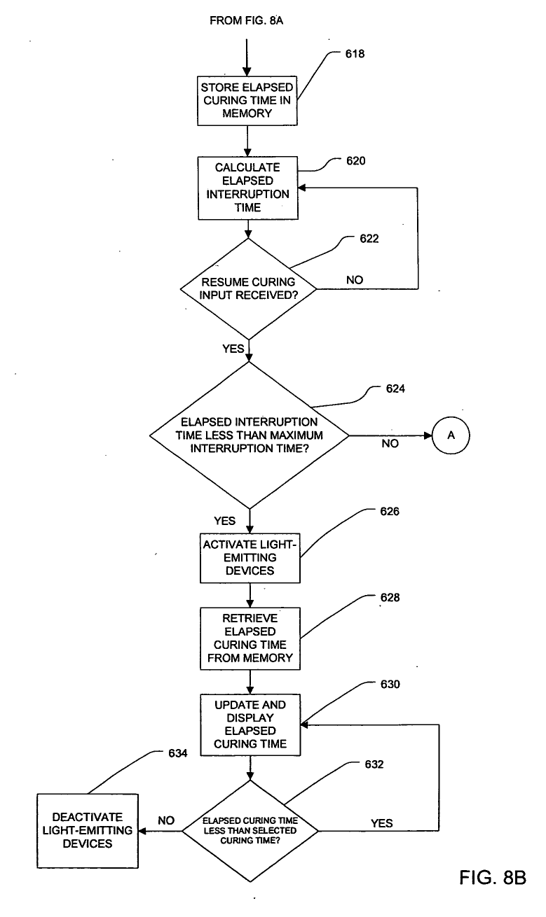

Referring now to FIG. 8A, a high level process flow of operations executed by processor 200 in one embodiment of the invention will now be described. As indicated at block 600, a curing time is received at an input, such as first input 304. The curing time may also be displayed at display 302. The curing time is stored in memory 202, as indicated at block 602. The next step is checking for an input signal indicating that curing is to commence, as indicated at block 604. The user may provide such an input signal by pressing an on/off button, which may be second input 306, for example. If the input signal is received, then the light-emitting devices are activated, as indicated at block 606. During this time, the processor calculates the elapsed curing time, and optionally display the elapsed curing time, as indicated at block 608. The processor compares the elapsed curing time to the stored curing time, as indicated in block 610. If the elapsed curing time is not less than the stored curing time, the light emitting devices are deactivated, as indicated at block 612. Otherwise, the process continues, with the processor checking for an input signal directing an interruption in curing, as indicated at block 614. The user may provide such an input signal by pressing an on/off button, for example. If an input signal directing an interruption in curing is received, then the light emitting devices are deactivated, as indicated at block 616. If no such input signal is received, then the process flow returns to comparing the elapsed time to the stored curing time.

Continuing to FIG. 8B, the elapsed curing time as of the time the light emitting devices were deactivated, or as of the time the input signal directing an interruption in curing is received, is stored in memory, as indicated at block 618. The elapsed interruption time is calculated, as indicated at block 620. The user inputs are monitored for an input instructing resumption of curing, as indicated by block 622. If that instruction is received, then the elapsed interruption time is compared to a maximum interruption time, as indicated by block 624. The maximum interruption time may be predetermined. If the elapsed interruption time is less than the maximum interruption time, then the light-emitting devices are reactivated, as indicated by block 626, and the elapsed curing time is retrieved from memory, as indicated by block 628. The elapsed curing time is updated, from the retrieved elapsed curing time, and displayed, as indicated by block 630. The elapsed curing time is compared to the selected curing time until the selected curing time is reached, as indicated by block 632. Then the light-emitting devices are deactivated, as indicated by block 634. If the elapsed interruption time is equal to or greater than the maximum interruption time, then the process flow returns to the commencement of curing, on FIG. 8A.

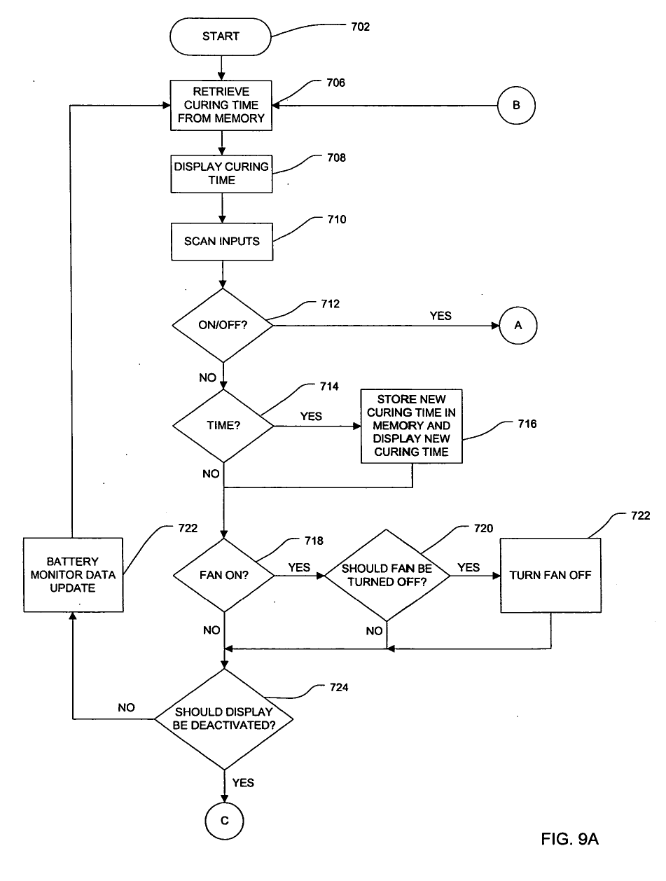

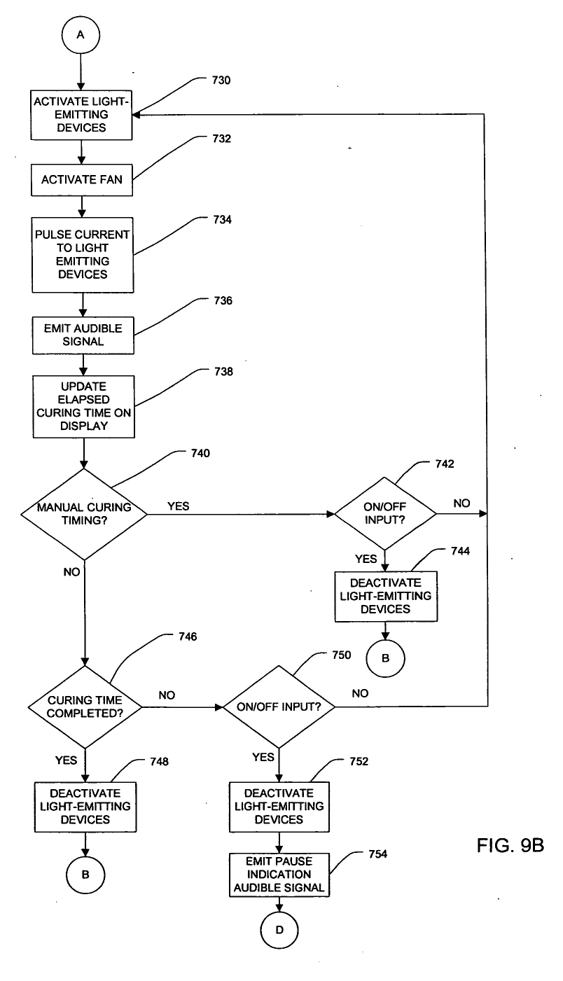

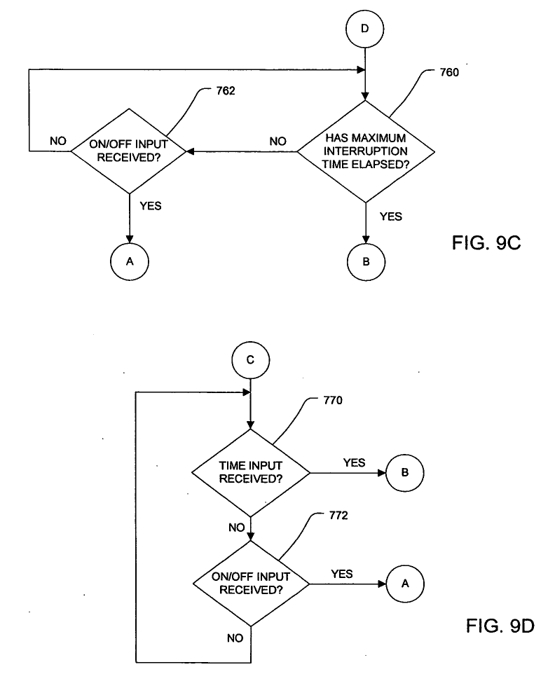

Referring now to FIG. 9A, a flow diagram illustrating an exemplary implementation of a process flow according to the invention will be described. In this embodiment, there are two user inputs, namely an ON/OFF button or switch, and a TIME button or switch. In this embodiment of the invention, the device has a number of modes, including a turned-off mode, in which the device is not operating, and an in-use mode, in which the light-emitting devices are activated, an idle mode, in which the processor and display are operating, and a paused mode, in which the light-emitting devices are deactivated, but curing may be resumed. In FIG. 9A, the process flow in the idle mode will be explained. From the initial start-up, as indicated by block 702, or from entering idle mode from another mode, the first step is retrieving the curing time from memory, as indicated by block 706. The retrieved curing time is then displayed on the display, as indicated by block 708. The process flow then proceeds to scanning the inputs, as indicated by block 710. If the ON/OFF input has been activated, then the process flow proceeds, as indicated by block 712 and reference A, to the in-use mode, illustrated in FIG. 9B. If the TIME input has been activated, the process flow proceeds to display and store the new time in memory, as indicated by blocks 714 and 716. The pressing of the TIME input may cause the processor to increment the curing time to the next greater curing time. For example, the stored curing time may be incremented by 5 or 10 seconds. In some embodiments, a maximum possible curing time may be provided. This maximum curing time may be, for example, 60 or 90 seconds. In these embodiments, if the curing time is already at the maximum, then pressing the button may change the processor from a timed curing state to a non-timed curing state. In a non-timed curing state, curing continues until an input, such as pressing an ON/OFF button, is received. Alternatively, incrementing from the maximum may cause the stored curing time to rotate to a minimum curing time.

The process flow then proceeds to determine if the fan is on, as indicated by block 718. If the fan is on, then a decision is made whether the fan should be on, according to current data and criteria for inactivating a fan, as indicated at block 722. Typically, a fan is powered whenever the light-emitting devices are activated. The criteria for deactivating the fan may include comparing a detected temperature of air or of heat sensors to a maximum activation temperature below which the fan is deactivated. The criteria may include deactivation a certain duration after deactivation of the light-emitting devices. If the criteria show that the fan should be off, then the fan is deactivated, such as by opening a switch that provides power to a fan motor, as indicated at block 720. The process flow then proceeds to a step of determination whether criteria have been met for deactivating the display, as indicated at block 722. The criteria for deactivating the display may be, for example, that a certain period of time has elapsed subsequent to the last time a button was pressed. The period of time may be selected as desired, and may be between about 2 minutes and about 5 minutes, by way of example. If the criteria have been met, then the unit is taken into an off mode, in which the display is no longer powered. If the criteria have not been met, then the process flow proceeds to checking the battery state, as indicated by block 724. The current battery status is determined. The display may include an indication of whether the battery is being charged and the remaining charge on the battery. The display may be, for example, a numeric value for the remaining charge, or selected colored lights designating remaining charge between various thresholds. A flashing light or other indicator selected to attract the attention of a user may be provided if battery charge is below a selected minimum threshold. After updating of battery data, the process flow returns to retrieving stored data from memory.

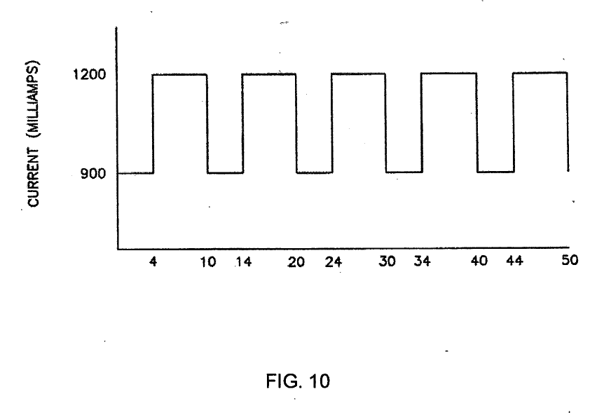

Referring to FIG. 9B, a process flow executed by the processor when the device is in an in-use mode is illustrated. The in-use mode commences upon receipt of an ON/OFF signal, as discussed above in connection with FIG. 9A. At a first step, indicated at block 730, the light-emitting devices are activated, typically by providing a current through the light-emitting devices. A fan is activated, as indicated at block 732, by providing power to a fan motor. The current provided to the light emitting devices may be pulsed, as indicated by block 734. A higher light output may be obtained in some embodiments by providing a pulsed current. An exemplary pulsed current is shown in FIG. 10.

A sonic signal may be emitted as an additional indication that the curing light is activated, as indicated at block 736. By way of example, a short tone or beep may be emitted at regular intervals, such as every 5 or 10 seconds. As indicated at block 738, the elapsed curing time is updated and displayed on the display. The time may be updated at regular intervals, such as each second. The elapsed curing time is preferably also stored in memory.

The process flow differs depending on whether the unit is set for manual curing timing or automatic curing timing for a selected period. If the unit is set for manual curing timing, as indicated by blocks 740 and 742, the processor checks for an ON/OFF input. If no such input is received, then the process flow continues. If the ON/OFF input has been received, then the light-emitting devices are deactivated, as indicated at block 744. The process flow then proceeds to the idle mode explained above with respect to FIG. 9A.

If manual curing timing has not been selected, the process flow proceeds to check to see if the curing time has been completed, as indicated at block 746. In other words, a check is made to see if the elapsed curing time is equal to or greater than the selected curing time. If the curing time has been completed, then the light-emitting devices are deactivated, as indicated at block 748. The process flow then proceeds to the idle mode explained above with respect to FIG. 9A. If the curing time is not completed, the process flow proceeds to check for an ON/OFF input, as indicated by block 750. If an ON/OFF input has been received, then the light-emitting devices are deactivated, as indicated at block 752. An audible signal is emitted, which may be an audible signal that indicates a paused mode, as indicated at block 754. The audible signal for a paused mode may be different from the audible signal emitted periodically during curing. For example, the audible signal for a paused mode may be of a different pitch, different duration, repeat the same signal or different signal two or more times, or one or more combinations of the above. The difference in signals should be sufficient that the user will be aware that the audible signal for a paused mode is not the audible signal indicating curing. The process flow then proceeds to a paused mode, explained below with reference to FIG. 9C. If no ON/OFF input has been received, then the process flow continues with activated light-emitting devices, an activated fan, pulse current provided to light emitting devices, the audible signal is emitted.

Referring now to FIG. 9C, operation in a paused mode will now be explained. The paused mode commences if the device is being operated using a set maximum curing time, and an ON/OFF input is received. In the paused mode, the process flow checks for whether the maximum interruption time has elapsed, as indicated by block 760. The maximum interruption time may be set at a desired duration. The duration may be selected depending on the effect of interruption on the curing of adhesives. The maximum time may be, by way of example, 5 seconds, 10 seconds, 20 seconds, 30 seconds, or another value within, below, or above the range of about 5 seconds to about 30 seconds. If the maximum interruption time has elapsed, then the unit proceeds to the idle mode explained above with reference to FIG. 9A. The stored remaining curing time may be deleted from memory at this point in the process flow. If the maximum interruption time has not elapsed, then the process flow proceeds to check for receipt of an ON/OFF input, as indicated by block 762. If an ON/OFF input has been received, then the process flow proceeds to the in-use mode as explained above with reference to FIG. 9B. If no ON/OFF input has been received, then the process flow returns to determining whether the maximum interruption time has elapsed after the light-emitting devices were deactivated.

Referring now to FIG. 9D, a process flow is illustrated for an off or powered-down mode of the unit. The unit enters this mode, as described above, after a sufficient time in idle mode with no input and the fan or other cooling device permitted to be inactive. In the powered-down mode, the processor checks for inputs. In a first step of the process, as indicated at block 770, the process checks to see if a TIME input has been received. If a TIME input has been received, then the unit proceeds to its idle mode. If not, then, as indicated at block 772, the process flow checks for an ON/OFF input. If an ON/OFF input has been received, then the unit proceeds to the in-use mode described above with reference to FIG. 9B. If not, then the process flow returns to checking for a TIME input.

In an embodiment of the invention, light-emitting devices may be driven in accordance with a signal illustrated at FIG. 10. The current is stepped between 900 and 1200 milliamps in 10 millisecond cycles, with the current at 900 milliamps for 4 milliseconds and at 1200 milliamps for 6 milliseconds of each cycle. The operating voltage is 4.2V. Power output of between about 700 and about 1200 mW/cm² may be obtained using this driving signal.

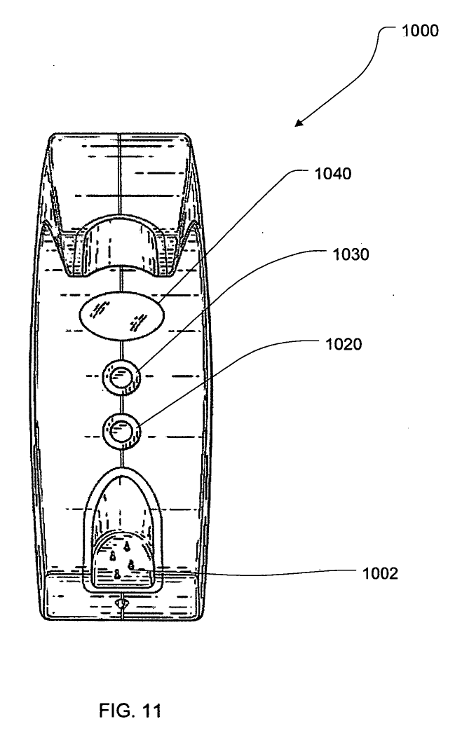

Referring to FIG. 11, a base or cradle 1000 for a radiation emitting unit, such as that shown in FIG. 1, is illustrated. Cradle 1000 has electrical connectors, shown at 1002, for providing a charging current to a unit 10. Cradle 1000 is also adapted to support a unit 10. Cradle 1000 has a housing having a generally continuous outer wall, having first radiometer port 1020 and second radiometer port 1030 defined therein. Electrical connectors 1002 are also associated with the housing, and may protrude from one or more openings or be accessible through one or more openings in the housing. First radiometer port 1020 and second radiometer port 1030 may have associated therewith detectors for measuring radiation in different wavelength ranges. Display 1040, which may be a numeric display, provides an output in accordance with data provided by suitable processing electronics location in cradle 1000. First radiometer port 1020 may have associated therewith a detector for measuring radiation in the infrared range, and second radiometer port 1030 may have a detector for measuring radiation in the ultraviolet range. The detectors are positioned in the radiometer ports so that, for example, when unit 10 is held with its output near and directed toward the radiometer port, radiation emitted by unit 10 is detected by the associated detector. The detectors associated with respective radiometer ports 1020, 1030, may provide output signals representing the intensity of detected radiation to a suitable processor. The processor may be programmed to, when a signal indicating detected radiation above a threshold representing a low background amount is received, cause display 1040 to provide a numeric reading. Display 1040 is also associated with the housing, and may be, by way of example, an LCD display visible in an opening in the housing. The numeric reading may be in units of milliwatts per centimeters squared. This is advantageous, as an excessively low UV reading indicates that the unit 10 will not provide sufficient radiation for curing. An excessively high infrared reading indicates problems such as overheating in unit 10.

While the foregoing invention has been described with reference to the above described embodiments, various modifications and changes can be made without departing from the spirit of the invention. Accordingly, all such modifications and changes are considered to be within the scope of the invention.

What is claimed is:

1. A device for providing radiation to a selected incident area comprises:
(a) a first light emitting device adapted to emit light in a band having a peak at a first wavelength;
(b) a plurality of second light emitting devices adapted to emit light in a band having a peak at a second wavelength, said second light emitting devices being arranged circumferentially about said first light emitting device;
(c) at least a first optical component for providing light emitted by said first light emitting device to the selected incident area; and
(d) at least a second optical component for providing light from said second light emitting devices to said selected incident area.

2. The device of claim 1, wherein said first wavelength is from about 455 nm to about 475 nm.

3. The device of claim 1, wherein said second wavelength is about 405 nm.

4. The device of claim 1, wherein said first optical component comprises a collimator located to receive light emitted by said first light emitting device and a first lens located to receive light from said collimator and to provide light to the selected incident location.

5. The device of claim 1, wherein said first optical component comprises an elliptical reflector located to reflect light emitting by said first light emitting device to the selected incident area.

6. The device of claim 1, wherein said second optical component comprises a lens.

7. The device of claim 6, wherein said lens is circumferential to said at least first optical component.

8. A method for providing radiation to a selected incident area comprises the steps of:
(a) emitting light in a band having a peak at a first wavelength from a first light emitting device;
(b) simultaneously emitting light in a band having a peak at a second wavelength from a plurality of second light emitting devices arranged circumferentially about the first light emitting device;
(c) directing, by at least a first optical component, light emitted from the first light emitting device on the selected incident location; and
(d) directing, by at least a second optical component, light emitted from the second optical devices on the selected incident location.

9. The method of claim 8, wherein said first wavelength is from about 455 nm to about 475 nm.

10. The method of claim 8, wherein said second wavelength is about 405 nm.

11. The method of claim 8, wherein said step of directing by at least a first optical component comprises collimating said light emitted from the first light emitting device and focusing said collimated light in a first lens.

12. The method of claim 8, wherein said step of directing by at least a first optical component comprises reflecting, by an elliptical reflector, said light emitted from the first light emitting device.

13. The method of claim 8, wherein said second optical component comprises a lens.

14. The method of claim 8, wherein said lens is circumferential to said first optical component.

15. A method of operating a dental curing unit, comprising the steps of:
(a) upon receiving a first curing start input, causing the dental curing unit to commence radiation emission for curing;
(b) interrupting radiation emission in response to receiving an interruption signal;
(c) determining an elapsed interruption time; and
(d) upon receiving a second curing start input, causing the dental curing unit to continue radiation emission for the remainder of a selected curing time stored in memory if the determined elapsed interruption time is less than a maximum interruption time, and otherwise resuming radiation emission for the entire selected curing time.

16. The method of claim 15, further comprising the steps of receiving an indication of a selected curing time and storing the selected curing time in memory.

17. The method of claim 15, further comprising the steps of determining and displaying an elapsed curing time during the step of emission of radiation.

18. The method of claim 15, further comprising the step of emitting a paused mode audible signal after receiving said interruption signal and before receiving said second curing start input.

19. The method of claim 15, further comprising the steps of receiving a maximum interruption time and storing the received maximum interruption time in memory.

20. A cradle for a radiation emitting unit, comprising:
(a) a housing having a generally continuous outer wall;
(b) at least one electrical connector, associated with said housing, for providing current to a radiation emitting unit associated with said housing;
(c) a first radiometer port defined in said wall and having associated therewith a detector for measuring radiation in the infrared range;
(d) a second radiometer port defined in said wall and having associated therewith a detector for measuring radiation in the ultraviolet range; and
(e) a display associated with said housing for displaying radiation intensities detected by said detectors.
